(19) United States
(12) Patent Application Publication
(10) Pub. No.: US 2010/0251337 A1
(43) Pub. Date: Sep. 30, 2010

(54) SELECTIVE DISTRIBUTION OF OBJECTS IN A VIRTUAL UNIVERSE

(75) Inventors: Jeffrey David Amsterdam, Marietta, GA (US); Rick Allen Hamilton, II, Charlottesville, VA (US); Brian Marshall O'Connell, Cary, NC (US); Clifford Alan Pickover, Yorktown Heights, NY (US); Keith Raymond Walker, Austin, TX (US)

Correspondence Address: DUKE W. YEE, YEE AND ASSOCIATES, P.C., P.O. BOX 802333, DALLAS, TX, 75380, US

(73) Assignee: INTERNATIONAL BUSINESS MACHINES CORPORATION, Armonk, NY (US)

(21) Appl. No.: 12/413,103

(22) Filed: Mar. 27, 2009

(51) Int. Cl. G06F 15/16; H04L 9/32; G06F 3/048

(52) U.S. Cl. 726/4; 715/757

(57) ABSTRACT

A method, product, and system are directed to selective distribution of a virtual universe in a virtual universe. In one embodiment, permission is granted to access the virtual universe, whereby a user navigates to a region. Metadata is detected in a user's profile. A virtual universe object is detected in the region. The virtual universe object includes a tag, which includes one or more fields. The tag and the metadata are compared. A level of similarity is detected between the tag and the metadata in the user's profile. Responsive to detecting the level of similarity between the fields included with the tag and the metadata in the user's profile, the virtual universe object is presented to the user. Either an acceptance or a rejection of the virtual universe object is received. Responsive to receiving an acceptance, the virtual universe object is included in the user's inventory.

### BACKGROUND

1. Field of the Illustrative Embodiments

The disclosure relates generally to a data processing system for distributing relevant virtual universe objects and more specifically to a user in a virtual universe. Still more particularly, the illustrative embodiments are directed to a computer implemented method, computer program product, and data processing system for expediting access to the relevant objects by comparing descriptive tags associated with virtual universe objects to a user's profile existing in the virtual universe.

2. Description of the Related Art

A virtual universe is a computer-based environment intended for its residents to traverse, inhabit, socialize, and interact through the use of avatars. A virtual universe simulates the actual, tangible, physical universe. Avatars are virtual characters, usually in an animated format. The avatars represent human users that have an account with a virtual universe application. Virtually everything associated with the avatars is completely customizable. Avatars can be made to travel from one location to another within a virtual universe. Teleporting is the process of instantly changing from one location to another upon a user selecting a button that allows for teleporting. Virtual universes use three-dimensional (3-D) graphics to create a virtual world with extremely realistic images and backgrounds.

Within the virtual universe, an avatar often searches for virtual objects that are of use to the avatar. Virtual universe objects may include virtual documents, various tools, and the applications used to access these documents and tools.

Most virtual universe applications include various methods for providing an object to a user based on the user's entering a specific location. Current methods also include providing an object to a user based on the elapsing of a specific amount of time. Also, objects may be provided to a user if a user belongs to an authorized group or if a user has completed a task or attained a level of proficiency

### SUMMARY

According to one or more of the illustrative embodiments, a computer-implemented method, apparatus, and computer program product are directed to a selective distribution of a virtual universe in a virtual universe. In one embodiment, the computer implemented method comprises granting permission to access the virtual universe. A user navigates to a region within the virtual universe application. Metadata is detected in a user's profile. A virtual universe object is detected in the region. The virtual universe object includes a tag, which includes one or more fields. The tag and the metadata are compared. A level of similarity is detected between the one or more fields included with the tag and the metadata in the user's profile. Responsive to detecting the level of similarity between the fields included with the tag and the metadata in the user's profile, the virtual universe object is presented to the user. Either an acceptance or a rejection of the virtual universe object is received. Responsive to receiving an acceptance, the virtual universe object is included in the user's inventory.

### BRIEF DESCRIPTION OF THE SEVERAL VIEWS OF THE DRAWINGS

FIG. 1 is a pictorial representation of a network of data processing systems in which illustrative embodiments may be implemented.

FIG. 2 is a block diagram of a data processing system in which illustrative embodiments may be implemented.

FIG. 3 is a block diagram illustrating virtual universe environment in accordance with an illustrative embodiment.

FIG. 4 is a pictorial diagram illustrating components of a user's profile on a virtual universe application in accordance with an illustrative embodiment.

FIG. 5 is a flowchart illustrating a method for distributing relevant objects to a user within a virtual universe in accordance with an illustrative embodiment.

### DETAILED DESCRIPTION

As will be appreciated by one skilled in the art, the illustrative embodiments may be embodied as a system, method or computer program product. Accordingly, the illustrative embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the illustrative embodiments may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the illustrative embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The illustrative embodiments is described below with reference to flowchart illustrations and/or block diagrams of methods, apparatus (systems) and computer program products according to embodiments of the illustrative embodiments. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

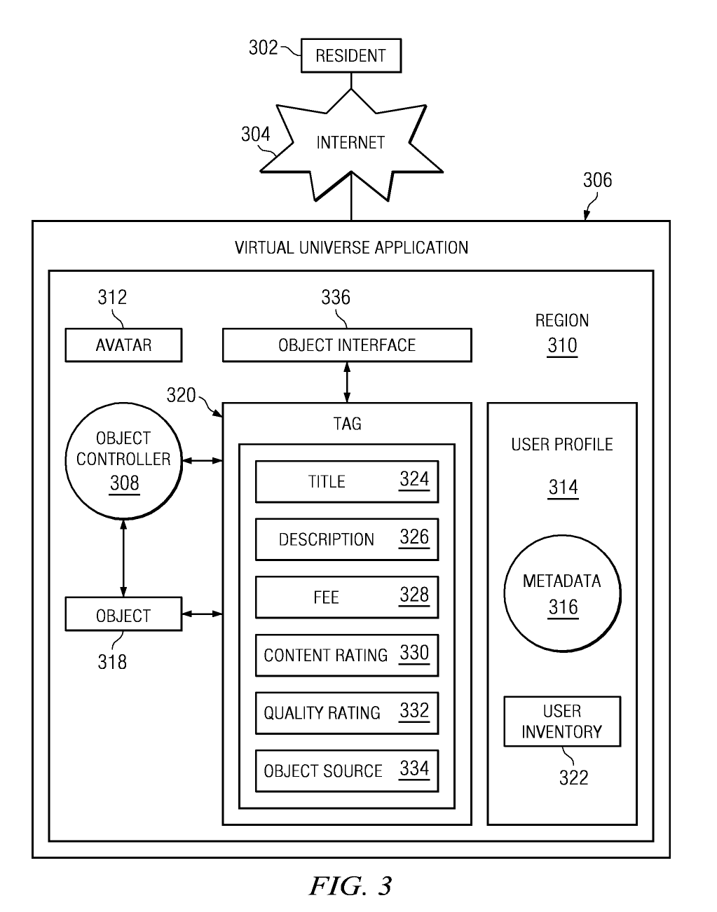

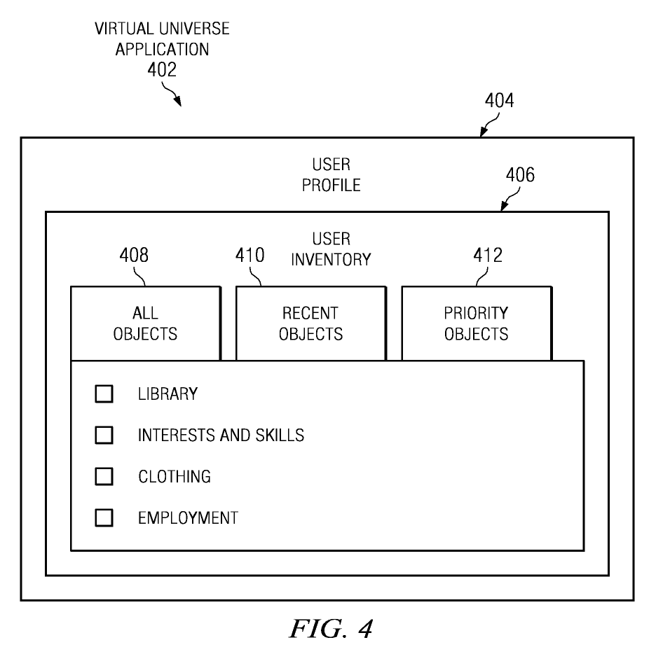

Networked data processing system 100 is a network of computers in which different illustrative embodiments may be implemented. Networked data processing system 100 contains network 102, which is the medium used to provide communications links between various devices and computers connected within networked data processing system 100. Network 102 may include permanent or temporary connections, and wireless or land line connections. In the depicted example, servers 104 and 106 are connected to network 102, along with storage unit 108. In addition, clients 110, 112 and 114 are also connected to network 102. These clients, 110, 112 and 114, may be, for example, personal computers or network computers. Clients 110, 112, and 114 may be users of a virtual universe application, such as virtual universe application 306 in FIG. 3 and virtual universe application 402 in FIG. 4, in accordance with the illustrative embodiment. The virtual universe application may be located on either server 104 or server 106 and accessible to clients 110, 112, and 114 over network 102.

In the depicted example, server 104 provides data, such as boot files, operating system images and applications, to clients 110-114. Clients 110, 112 and 114 are clients to server 104 and 106. Networked data processing system 100 may include additional servers, clients, and other devices not shown.

In the depicted example, networked data processing system 100 is the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, networked data processing system 100 also may be implemented as a number of different types of networks such as, for example, an Intranet or a local area network.

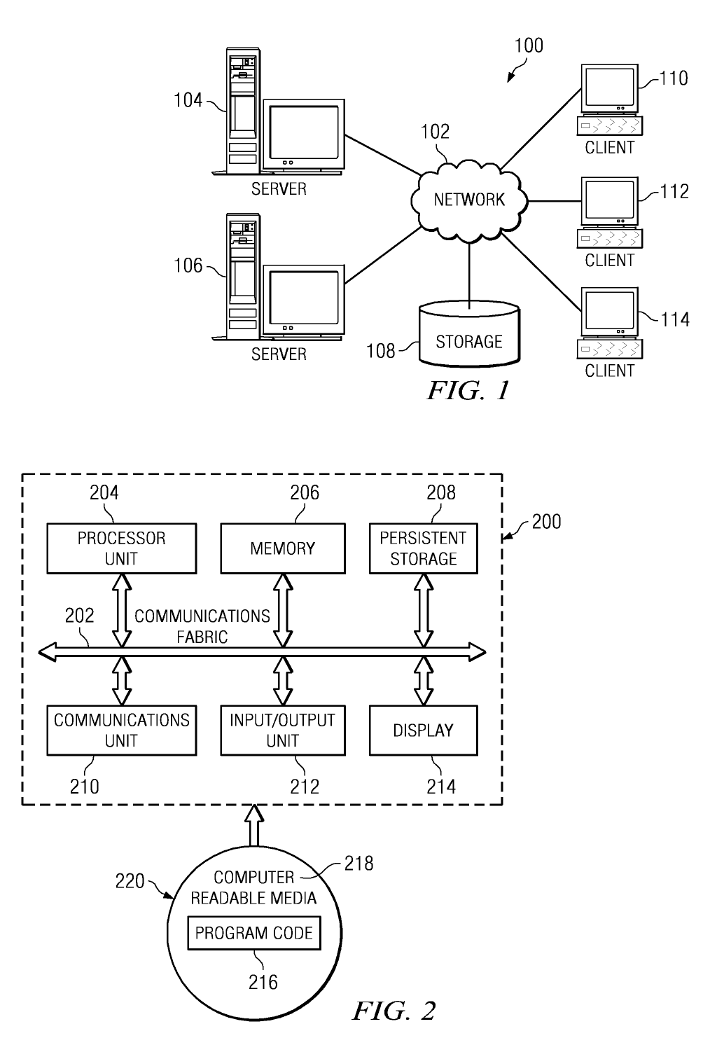

FIG. 1 is intended as an example and not as an architectural limitation for the processes of the different illustrative embodiments.

Turning now to FIG. 2, a diagram of a data processing system is depicted in accordance with an illustrative embodiment. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer readable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. As one example, a storage device in data processing system 200 is any hardware apparatus that may store data. Memory 206, persistent storage 208 and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache, such as found in an interface and memory controller hub that may be present in communications fabric 202

The illustrative embodiments recognize a need for expediting access to objects relevant to a client's surroundings and making these objects easily available to users of a virtual universe. Currently, no prior art exists that allows a user's profile, including preferences to affect the user's ability to access a virtual universe object. Additionally, no prior art exists that provides for a system that predicts the needs of a user based on information contained in a user's profile and descriptive tags paired with virtual universe objects. The illustrative embodiments disclosed distribute virtual universe objects by comparing descriptive tags associated with the virtual universe objects to a user's profile. The user is assisted in receiving virtual universe objects that are more relevant and tailored to the user as compared to prior solutions available for granting access to virtual universe objects.

The different illustrative embodiments recognize and take into account a number of considerations. For example, the different illustrative embodiments recognize and take into account that the currently available method for providing virtual universe objects may be lacking. More sophisticated methods are needed for providing virtual universe objects to a user based on the user's profile and characteristics. The different illustrative embodiments also recognize that it is desirable for the virtual universe technology to include a method for providing objects to a user based on a relationship between the objects and key words and other descriptors from a user's profile.

Therefore, the illustrative embodiments recognize a computer-implemented method, apparatus, and program product for distributing and accessing objects in a virtual universe is needed. In one illustrative embodiment, permission is received to access a virtual universe application. A user navigates to a region within the virtual universe application. Metadata is detected in a user's profile. Metadata, as used herein, is data that describes other data. The metadata includes words, symbols, and other visual cues that provide pertinent information about a user. The metadata is located in a user's profile. The user's profile appears to the user as an interface in the virtual universe in which a user may enter text describing characteristics, employment, hobbies, interests, skills, and other personal information about the user.

Next, a virtual universe object is detected in the region. In one embodiment, the virtual universe object includes a tag, which includes one or more fields that further describe the virtual universe object. The tag and the metadata are compared. A level of similarity is detected between the one or more fields included with the tag and the metadata in the user's profile. Responsive to detecting the level of similarity between the fields included with the tag and the metadata in the user's profile, the virtual universe object is presented to the user. Either an acceptance or a rejection of the virtual universe object is received. Responsive to receiving an acceptance, the virtual universe object is included in the user's inventory.

FIG. 3 is a block diagram illustrating a virtual universe environment in accordance with an illustrative embodiment. In this illustrative example, virtual universe environment 300 may implemented in network data processing system 100 in FIG. 1 using a set of data processing systems, such as data processing systems 200 in FIG. 2. The term “set” as included herein and throughout the application refers to at least one or more.

In FIG. 3, resident 302 represents a user within a virtual universe, such as virtual universe 306. Virtual universe application 306 is located on a server, such as server 104 or server 106 in FIG. 1.

Virtual universe application 306 is a software program that simulates a virtual universe on a data processing system. Virtual universe 306 allows for its users to inhabit a virtual universe and interact via avatars, such as avatar 312. Avatar 312 is a representation of a user in virtual universe 306.

A commonly known virtual universe application includes the virtual universe application known as Second Life™. However, other virtual universe applications include Active Worlds™, There™, Entropia™, Universe™, Forterra™, and others. Virtual universe application 306 is not limited to any of these listed names, but may be applicable to these and other virtual universe applications. Generally, virtual universe applications, such as virtual universe application 306, allow people to interact through digital personas or avatars, such as avatar 312. Many third-party companies now provide these services to individuals and organizations, sometimes free of charge. Resident 302 possesses an avatar within the virtual universe. Users within such virtual universe applications are also referred to as “residents” or “clients”.

Virtual universe application 306 includes virtual universe owners and virtual universe administrators. The main difference between virtual universe owners and administrators is that the virtual universe owners determine the policies and make decisions about settings and thresholds, while the virtual universe administrators are responsible for the practical application of these policies, settings, and thresholds to virtual universe 306.

Avatar 312 represents a single avatar that may be used by resident 302 in virtual universe 306. In virtual universe application 306, residents socialize, participate in individual and group activities, and create and trade items and services with one another. Avatar 312 is essentially an online virtual graphical representation of a user. A user has the ability to choose how to identify avatar 312. Avatar 312 may be a three-dimensional graphical representation or a two dimensional representation, such as a picture or an icon. However, virtual universe 306 permits avatars to move through the universe in this three dimensional mode.

Resident 302 connects through the internet, shown as internet 304, to access virtual universe 306. Internet 304 may be implemented over a network, such as network 102 in FIG. 1. Internet 304 represents a worldwide collection of networks and gateways that use the TCP/IP suite of protocols to communicate with one another. At the heart of Internet 304 is a backbone of high-speed data communication lines between major nodes or host computers consisting of thousands of commercial, government, education, and other computer systems that route data and messages.

Region 310 is also included in virtual universe application 306. Region 310 is one of a set of regions. Region 310 includes at least one virtual area of land within the virtual universe. A region in a virtual universe typically resides on a single server. Users may teleport from one region to another. Teleportation comprises re-rendering an avatar, such as avatar 312, in a new environment. Through teleportation, users may cross the threshold from one distinct region to another region within virtual universe application 306. Region 310 is a region in virtual universe application 306 that may simulate a landscape that includes any number of other avatars, buildings, geographical bodies such as lakes, trees, beaches, homes. Users of virtual universe application 306 have the ability to teleport or navigate to any number of regions within virtual universe application 306. The wide variety of regions in virtual universe application 306 allows a user to maximize use in virtual universe application 306 for business related purposes as well as purely personal or entertainment related purposes.

Typically, in virtual universe application 306, resident 302 logs onto and is granted access to the virtual universe. Resident 302 has a unique identifier or password that is requested and must be supplied to virtual universe application 306. In one illustrative embodiment, upon being granted access, resident 302 is located in a region correlating to the last region in which the resident had been located before leaving the virtual universe. If this is not the case, resident 302 may request to be teleported to any region that the resident desires to proceed to in the virtual universe.

In an illustrative embodiment, object 318 may include any type of tool, document, or application available and useful to an avatar within a virtual universe. Documents may include printed text and/or graphics. Applications are usually web-based applications that allow a user to manipulate and access objects in the virtual universe context. For example, an application in a virtual universe may simulate a document editing application, such as Microsoft Word™. Such applications allow a user to edit and save any changes to documents provided in virtual universe application 306, however the document editing application appears to the user within the interface of virtual universe 306.

Object 318 includes items replicated to look and function like items available in a non-virtual universe setting. Thus, object 318 may include useful tools for an avatar that are virtual representations of real world items, whereby the virtual tools also provide a specific function in virtual universe 306. For example purposes only, and without limitation as to other possibilities, these items may include virtual calculators, computers, toys, portable music players, furniture, vehicles, and various reading materials, such as books or magazines. Object 318 is comprised of a set of objects that may be both relevant and non-relevant to a user in virtual universe 306. Furthermore, object 318 may be any item that correlates to an avatar's personal appearance, or to a listed hobby, or listed profession in a user's inventory.

In an illustrative embodiment, object 318 also includes a descriptive tag, included in FIG. 3 as tag 320. Tag 320 comprises a label that provides information regarding object 318. In these illustrative examples, tag 320 is in the form of text. However, tag 320 may also be a combination of both text and non-text icons or pictures.

Tag 320 appears in conjunction with an icon or symbol representing object 318. In one embodiment, tag 320 may appear on any side of object 318, upon receiving a signal that a user has positioned a selector tool over object 318, wherein the selector tool may include, without limitation, a mouse or the arrow key functions on a keyboard. In one embodiment, tag 320 includes a border around the text included within tag 320. In this embodiment, the border around the text visually aids the user to separate the text information associated in tag 320. Tag 320 is utilized by object controller 308 to extract information about object 318.

Tag 320 may be created and edited by at least one of the following: object creators, object owners, object borrowers, object renters, virtual world administrators, authorized users, and all users. In some embodiments, tag 320 is always supplied at object creation. In case an object does not have at least one tag, the determination as to whether object controller 308 considers these objects to apply to all or no user contexts may be determined by either virtual universe owners or by a user. Additionally, a user may specify a setting included in user profile 314 whether object controller 308 should consider any object that does not include at least one tag.

Tag 320 is a description containing information relevant to object 318. Tag 320 may include information regarding the designer of the object, a memory size, or an associated cost to purchase the object if a cost is included. Furthermore, tag 320 may include information about an organization, entity, business, or set of users that may find the object within object 318 useful or relevant with which tag 320 is associated. Tag 320 may also include any description of the content and appearance of object 318.

Also, in FIG. 3, tag 320 includes title 324, description 326, fee 328, content rating 330, quality rating 332, and object source 334. Thus, in one illustrative embodiment, tag 320 may include all of these listed elements as part of tag 320. However, tag 320 may also only include one or two of these elements or may include additional elements not listed.

Title 324 is a title associated with a tagged object. Description 326 includes words describing the purpose, function, applicability, content, and/or appearance of the tagged object. Fee 328 is a field indicating whether a fee is associated with the tagged object. In virtual universe 306, some objects may include a fee before a user is able to acquire the objects. Content rating 330 comprises a numeric rating. In an illustrative embodiment, the numeric rating may range from a lowest to a highest number, indicating the usefulness and appeal of the tagged object. Content rating 330 may be set by general users of the tagged object. In one embodiment, an average of an accumulated number of ratings from the general users is taken and listed as the content rating 330. Quality rating 332 is another type of rating that may be included in tag 320. Quality rating 332 may utilize the Entertainment Software Rating Board™ (ESRB) ratings to provide further information to a user about the content and age appropriateness of the tagged object. The Entertainment Software Rating Board (ESRB) ratings are designed to provide concise and impartial information about the content in computer and video games so consumers, especially parents, can make an informed purchase decision. ESRB ratings have two equal parts known as rating symbols and content descriptors. Rating symbols suggest age appropriateness for the game. Content descriptors indicate elements in a game that may have triggered a particular rating and/or may be of interest or concern. Thus, quality rating 332 may correspond to the rating symbols commonly known as the ESRB ratings.

Tag 320 may further include a field related for object source 334, in which information regarding the object designer, creator, or owner may all be listed. Thus, FIG. 3 includes an illustrative embodiment, whereby a tagged object includes at least one of the following: a title, a description elaborating on the function, use, and applicability of the tagged object, a content rating, a quality rating, a fee, and information regarding the object designer and/or owner.

User profile 314 in a virtual universe includes descriptive information about the user's personal characteristics. Metadata 316 is comprised of this descriptive information, and is also data about other data. Metadata 316 may be a combination of information provided by both a user, region owner, and/or virtual universe operators. Metadata 316 includes information, without limitation, describing a user's profession, hobbies, skills, interests, personal appearance, and user preferences. User profile 314 is comprised of several user interfaces that allow a user, such as resident 302, to include personal and professional details. User profile 314 may also include information related to any set of objects already utilized and stored in a storage area associated with avatar 312.

Every user's avatar has a unique user profile. User profile 314 is unique for each user in virtual universe 306. Every user may enter in user profile 314, his or her own specific characteristics, preferences, and interests as related to virtual universe 306. Within user profile 314, object controller 308 is able to locate key words within metadata 316 that provide context and insight into which virtual universe object are relevant to a user.

User inventory 322 is included under user profile 314. User inventory 322 allows a user to store objects from object 318 to which a user has been granted access. User inventory 322 may include settings whereby the user may prioritize objects in terms of priority, by most recently used, or into other sub-folders within user inventory 322. A user may create as many sub-folders as desired within user inventory 322 for organizing virtual universe objects acquired within virtual universe 306. Thus, a user may interact with an interface that allows the user to manipulate the contents and arrangement of objects, such as object 318, in user inventory 322.

In an illustrative embodiment, object controller 308 is software included in virtual universe 306. Object controller 308 detects the similarity between object 318 and metadata 316 located in user profile 314. Object controller 308 interprets words, numbers, symbols, and any other items included in tag 320. Object controller 308 detects a level of similarity by comparing the content of metadata 316 to the content of tag 320 in order to detect a possible match between the user and the tagged object. Thus, object controller 308 parses and interprets the text associated with metadata 316 and text included within fields in tag 320, such as title 324, description 326, fee 328, content rating 330, quality rating 332, and object source 334. Object controller 308 parses and analyzes these fields to determine if object 318 may be relevant to a user

Object controller 318 determines a level of similarity between object 318 and user profile 314. In order to detect a level of similarity, object controller parses the words included in a user profile. Additionally, object controller parses the words included in tag 320. Object controller detects a level of similarity. A level of similarity may be determined based on a threshold number of words that overlap between tag 320 and user profile 314. In order to determine the level of similarity, object controller 308 may utilize a text similarity algorithm to calculate a probability of a match. Text similarity algorithms are commonly known in the prior art and may be incorporated in one embodiment. Various test similarity algorithms exist that are capable of measuring shared words. Additionally, some text similarity algorithms measure shared letters, words stems. Word stems, as used herein, refers to a stem or a part of of a word that is common to all its inflected variants. For example, the word stem of “waiting” and “waited” is “wait”.

Some text similarity algorithms are also capable of measuring shared vocabularies and even shared meanings. Text similarity algorithms that are capable of measuring shared meanings are more sophisticated and required greater processing ability on the part of a data processing system hosting the virtual universe application. In one embodiment, object controller 308 utilizes a combination of text similarity algorithms to determine a level of similarity between tag 320 and user profile 314.

Additionally, object controller 308 may utilize another technique known as metadata field mapping, in which certain fields are set up in a user profile 314 that can be compared to fields set up in tag 320. Object controller 308 then analyzes the fields set up in a tag, such as tag 320, and the fields in a user's profile, such as user profile 314, to produce a number or range of numbers that indicate to object controller 308 whether there is an overall match between the user and the tagged object. For example, content rating 324 may be a field where there are a set of known values. User profile 314 may have a field for content rating, whereby the user enters an acceptable range of content ratings to the user. Object controller 308 analyzes and compares content rating 330 for object 318 to the content rating field in user profile 314. If content rating 324 and user profile 314 have an equivalent field, object controller 308 may determine that the tagged object is of potential interest to a user. In other embodiments, object controller 308 may utilize both a text similarity algorithm and a metadata field mapping to detect a possible match.

For example purposes only, and with no intended limitation, avatar 312 may choose to travel to a virtual building belonging to IBM™ in virtual universe 306. User profile 314 includes key words indicating that avatar 312 is an employee at IBM™. User profile 314 may include a section listing a user's professional employment, for example, whereby a user includes the fact that he or she is an employee at IBM™. Object controller 308 detects an object, such as object 318. Object 318, in this example, is a document, whereby the document is titled “Benefits for IBM™ employees.” Based on the correlation between the terms located in the title of the document and user profile 314, object controller 308 presents the document entitled “Benefits for IBM™ employees” to resident 302. Resident 302 has the option whether to accept or reject this document. When resident 302 accepts this document, this document may be inserted into user inventory 322 for easy access.

In one embodiment, object controller 308 may require added security verification before granting final access of an object to a user. Thus, a user may be required to enter a password or other identifier in order to receive access to an object. This verification procedure may not apply to every object within a virtual universe. However, a designer of a virtual universe object may determine that a particular set of objects require authentication prior to granting a user access to this particular set of objects.

Thus, for the example previously presented regarding an IBM™ employee, the user is prompted for additional authentication prior to granting the user access to the document entitled “Benefits for IBM™ employees.” Thus, this additional security feature may be adjusted for varying objects within a region.

Additionally, an object 318 is presented responsive to a trigger condition. The trigger condition may include movement of avatar 312 from one region to another. Additionally, the trigger condition may include movement of avatar 312 from one section to another within a same region. Movement of avatar 312 may include teleportation from one region to another within virtual universe 306. In case of movement of avatar 312 from one section to another within the same region, object 318 may be distributed at various points throughout the same region.

In one embodiment, when object 318 is initially created, the object designer of object 318 associates code with object 318 that enables object controller 308 to detect that object 318 is located in region 310. An object controller, such as object controller 308, is configured to search for any virtual universe objects when a user first enters a region. As avatar 312 moves throughout region 310, object controller 308 determines the location of avatar 312 and compares this location to any tagged objects that are embedded near avatar 312. Next, object controller 308 parses the descriptive tags for the tagged objects. Based on the parsing, object controller 308 makes a determination as to whether the tagged objects are relevant to resident 302 by determining a level of similarity. Upon determining a threshold level of similarity exists , object controller 308 presents the tagged objects to resident 302 for either an acceptance or a rejection.

Utilizing this method, resident 302 is provided access to an object that he or she may not have known existed in virtual universe 306. Object controller 308, thus, provides virtual universe objects that are of relevance to a user, without the user having to search for or initially request these objects. The present method and system expedites granting objects that are relevant to a user.

In one illustrative embodiment, a user may indicate preferences within user profile 314 as to when object controller 308 presents any relevant objects. A user may be presented with all the virtual objects parsed and sorted by object controller 308, as soon as the user signs on and is granted access to virtual universe application 306. Thus, in this embodiment, a user is not presented with objects as the user navigates through region 310; rather, the user is presented with the virtual universe objects as soon as the user enters region 310. In this case, object controller 308 determines which objects are available within region 310, parses and compares the descriptive tags associated with the objects to user profile 314, and presents the selected objects to the user for either acceptance or rejection.

Upon presenting the object to the user, object interface 336 appears to a user in virtual universe application 306. Object interface 336 includes the title of the object and the descriptive tag associated with the object. Object interface 336 further includes selectors that a user may select to indicate whether the user accepts or rejects object 318.

In one embodiment, when object controller 308 presents the virtual universe object to the user, the virtual universe object may be inserted into user inventory 322. However, in other embodiments, the virtual universe object may be placed in a landscape within the region that appears within a user's view. Additionally, the virtual universe object may be placed on a user's avatar, such as avatar 312, wherein placement of the virtual universe object on the user's avatar comprises a graphical representation affixed to a body of the avatar.

FIG. 4 is a pictorial diagram illustrating components of a user's profile on a virtual universe application in accordance with an illustrative embodiment. FIG. 4 includes virtual universe application 402. Virtual universe 402 is a virtual universe application, such as virtual universe application 306 of FIG. 3. Also, user profile 404 is similar to user profile 314 in FIG. 3.

User inventory 406 is a location within a user's profile that allows for objects gathered throughout a virtual universe to be organized and stored. In one embodiment, objects may be categorized under several sub-headings for better access and organization. Priority objects 412 include objects granted a higher priority by the user. Objects included in priority objects 412 may have been initially selected by an object controller, such as object controller 308 in FIG. 3. Upon choosing to accept an object presented by an object controller, such as object controller 308, a user may assign a priority to the selected object for inclusion within user profile 404.

Additionally, in one embodiment, recent objects 410 include objects most recently acquired by a user. In one embodiment, recent objects 410 may be configured to include objects acquired after a specified period of time. Recent objects 410 may also be configured to list a pre-defined number of items.

All objects 408 lists all objects acquired by a user, however, these objects may be organized in several different categories according to the type or function of the object. In the illustrative embodiment in FIG. 4, categories included within all objects 408 are library, interests & skills, clothing, and employment. Thus, the categories included for all objects 408 allow a user to store objects acquired in virtual universe 402 according to functions or other characteristics of the virtual objects. For example, the category seen under all objects 408 as “employment” assists a user to efficiently locate objects that the user has already acquired and that are related to a user's business or employment purposes within virtual universe 402 in FIG. 4.

Objects may be sorted into categories established by the user or automatically included as part of the template associated with user inventory 406. One of ordinary skill in the art is aware that further embodiments and categories may be created within user inventory 406 to assist the user in more efficient and organized access to his or her objects in the virtual universe.

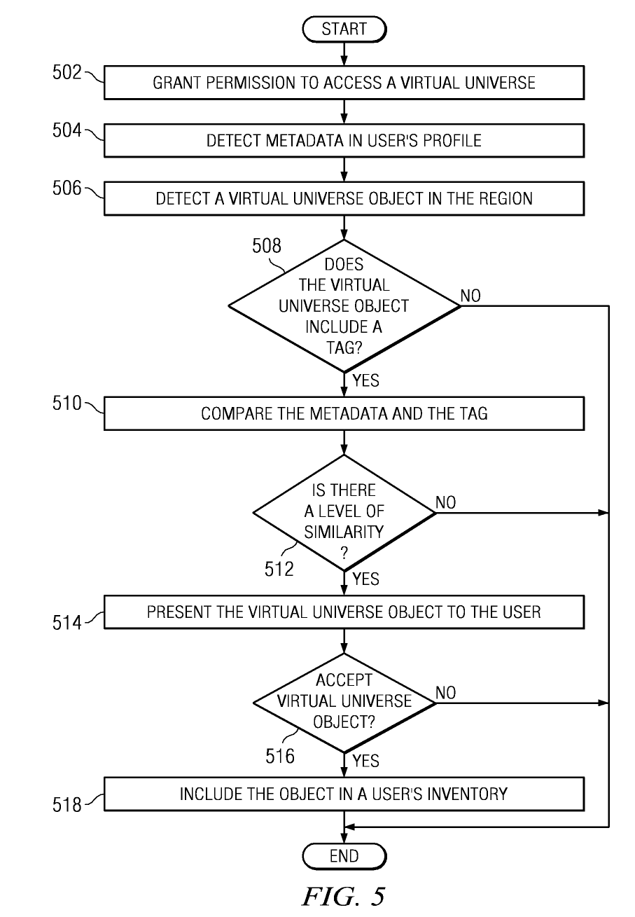

FIG. 5 is a flowchart illustrating a method for distributing relevant objects to a user within a virtual universe in accordance with an illustrative embodiment. In an illustrative embodiment, the method in FIG. 5 utilizes an object controller, such as object controller 314 in FIG. 3. Furthermore, the method in FIG. 5 may be implemented in a virtual universe application, such as virtual universe application 306 or virtual universe application 402.

In FIG. 5, the process begins by granting permission to access a virtual universe application (step 502). Permission is granted to a user of a virtual universe application, when a type of user identification and/or user specific password is supplied to the virtual universe application. Most user accounts with a virtual universe application are password protected and require authentication prior to granting access to a user to enter the virtual universe.

After initial permission is granted to a user of a virtual universe application, the user navigates to a region within a virtual universe. In one embodiment, an object controller, such as object controller 318, detects that the user has navigated to a region within the virtual universe. The user navigates his or her avatar through a virtual universe application by using a navigation tool associated with a data processing system. Such navigation tools include, without limitation, a computer mouse or keyboard including buttons for navigating an avatar on a virtual universe application. Virtual universe applications, such as virtual universe applications 306 and 402, allow users to navigate in regions designed for the virtual universe application by walking, running, flying in a same region or also by teleporting from one region to another.

Next, metadata is detected in a user's profile (step 504). The metadata is entered by a user in a user profile when a user initially sets up his or her user account in the virtual universe application. The user may alter or edit the user profile as often as desired. The user may provide any information in a user profile relating to the user. This information may be related to, without limitation, the user's avatar, personal characteristics, employment, interests, and/or skills. Thus, metadata, such as metadata 316 in FIG. 3, may be continuously changing. A virtual universe object is detected in a region within the virtual universe (step 506). An object controller, such as object controller 318 detects any virtual universe object located in the same region as the user's avatar. In one embodiment, when the virtual universe object is initially created, the object designer gives notice to an object controller that the object is located in a region. An object controller is configured to search for virtual universe objects when a user first enters a region. Furthermore, in one embodiment, object creators enable an object to be detected by an object controller when a user first enters a region. Virtual universe objects may be tools, documents, or applications. In this embodiment described herein, an object controller is enabled to detect objects embedded within a region for purposes of determining whether there is a level of similarity between the objects and a user profile.

The timing for presenting a virtual universe object to a user may be automatically determined by the virtual universe application or may be a user preference. In one embodiment, all virtual universe objects may be presented to the user when the user first enters a region of the virtual universe. In another embodiment, virtual universe objects may be presented depending on where the objects are located within the region and whether the user navigates to that specific location in the region corresponding to the location of the objects. In this embodiment, a user acquires these objects by navigating to the certain parts of the region. A user may configure a user setting for how and when the objects are presented.

For example, a user configures as a user preference to be presented with virtual universe objects as the user navigates through a region. If a user chooses to enter an IBM™ building located in a virtual universe application, the user may be presented with a document relevant to IBM™ employees. However, if the user did not enter the IBM™ building, based on the user preference selected, a user would not be presented with the document relevant to IBM™ employees since this document is tied to the IBM™ building and the user did not navigate to this specific location corresponding to the location of this particular virtual universe object.

In FIG. 5, a query is made whether the virtual universe object includes a tag (step 508). The tag, such as tag 320, includes descriptive information about the virtual universe object. If the virtual universe object does not include a tag, then the process terminates thereafter. However, if the virtual universe object includes a tag, then the process proceeds to compare the metadata and the tag (step 510).

A query is made whether there is a level of similarity (step 512). A level of similarity may be determined based on a threshold number of words that overlap between a virtual universe tag and a user profile, such as tag 320 and user profile 314 in FIG. 3. In order to determine the level of similarity, an object controller may utilize a text similarity algorithm to calculate a probability of a match or field data mapping, as previously discussed herein. If there is not a level of similarity, the process terminates thereafter. If there is a level of similarity, the virtual universe object is presented to the user (step 514).

Next, a query is made whether to accept a virtual universe object (step 516). The user is asked whether to accept or reject the virtual universe object. The user is provided with an object interface, such as object interface 336. Object interface 336 includes the title of the object and the descriptive tag associated with the object. Object interface 336 further includes selectors that a user may select to indicate whether the user accepts or rejects object 318 containing selectors and further descriptors of the virtual universe object. If the virtual universe object is rejected, then the process terminates thereafter. If the virtual universe object is accepted, then the object is included in a user's inventory (step 518). The process terminates thereafter.

Therefore, in one illustrative embodiment, permission is granted to access the virtual universe, whereby a user navigates to a region. Metadata is detected in a user's profile. A virtual universe object is detected in the region. The virtual universe object includes a tag, which includes one or more fields. The tag and the metadata are compared. A level of similarity is detected between the tag and the metadata in the user's profile. Responsive to detecting the level of similarity between the fields included with the tag and the metadata in the user's profile, the virtual universe object is presented to the user. Either an acceptance or a rejection of the virtual universe object is received. Responsive to receiving an acceptance, the virtual universe object is included in the user's inventory.

The illustrative embodiments allow for a sophisticated method of distributing virtual universe objects to a user in a virtual universe. Since virtual universe applications are becoming more and more popular for use in both personal and business related activities, there is a need for improving the available methods for distributing virtual universe objects. The illustrative embodiments provide a novel approach that compares personal information from a user's profile to tags associated with virtual universe objects. Thus, a user is provided with relevant and pertinent virtual universe objects that the user may or may not have known had existed by searching ahead of time for an object. In currently available virtual universe applications, a user is presented with virtual universe objects when the user manually searches for an object. Thus, a user must search and parse through available virtual universe objects through his or her own initiation. Another way in which a user may be presented with a virtual universe object is if the user is located in a region of the virtual universe that includes embedded objects that appear to a user as he or she navigates to certain locations in the region that correspond to the location of the embedded objects. However, no current methods or systems exist that attempt to predict relevance of an object to a user based on a comparison between a user's profile and an object's descriptive tag. Such an embodiment illustrated herein allows for objects that are of no relevance or interest to a user to be weeded out since these objects are not presented to a user if a level of similarity between the user's profile and the tagged object is not detected. Additionally, users are assisted in acquiring useful objects without the user having to perform a search to locate these objects since the object controller, as described herein, is continuously searching for any objects located within a virtual universe and attempting to determine whether the objects are relevant to a user. In a business related context, the illustrative embodiments will greatly assist a corporation or entity that encourages their employees to utilize a virtual universe application to engage in business related training and daily activities, such as meetings and project planning. Any virtual universe objects that must be supplied to an employee with an avatar in a virtual universe can be distributed quickly and efficiently utilizing the illustrative embodiments.

The flowchart and block diagrams in the figures illustrate the architecture, functionality, and operation of possible implementations of systems, methods and computer program products according to various embodiments of the illustrative embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the illustrative embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the illustrative embodiments has been presented for purposes of illustration and description, but is not intended to be exhaustive or limited to the illustrative embodiments in the form disclosed. Many modifications and variations will be apparent to those of ordinary skill in the art without departing from the scope and spirit of the illustrative embodiments. The embodiment was chosen and described in order to best explain the principles of the illustrative embodiments and the practical application, and to enable others of ordinary skill in the art to understand the illustrative embodiments for various embodiments with various modifications as are suited to the particular use contemplated.

The illustrative embodiments can take the form of an entirely hardware embodiment, an entirely software embodiment or an embodiment containing both hardware and software elements. In a preferred embodiment, the illustrative embodiments are implemented in software, which includes but is not limited to firmware, resident software, microcode, etc.

Furthermore, the illustrative embodiments can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the illustrative embodiments has been presented for purposes of illustration and description, and is not intended to be exhaustive or limited to the illustrative embodiments in the form disclosed. Many modifications and variations will be apparent to those of ordinary skill in the art. The embodiment was chosen and described in order to best explain the principles of the illustrative embodiments, the practical application, and to enable others of ordinary skill in the art to understand the illustrative embodiments for various embodiments with various modifications as are suited to the particular use contemplated.

What is claimed is:

1. A computer implemented method for distributing virtual universe objects in a virtual universe application, the computer implemented method comprising:
granting permission to access the virtual universe application;
detecting metadata in a user's profile;
detecting a virtual universe object in the region, wherein the virtual universe object includes a tag, wherein the tag comprises one or more fields;
comparing the metadata and the tag to form a comparison;
detecting a level of similarity between the one or more fields included with the tag and the metadata in the user's profile;
responsive to detecting the level of similarity between the fields included with the tag and the metadata in the user's profile, presenting the virtual universe object to the user;
receiving either an acceptance or rejection of the virtual universe object; and
responsive to receiving the acceptance, including the virtual universe object in a user's inventory.

2. The computer implemented method of claim 1, further comprising:
detecting a trigger condition for providing a user with the virtual universe object, wherein the trigger condition comprises movement of the user within the region of the virtual universe.

3. The computer implemented method of claim 1, wherein the user moves from one region to another through teleportation.

4. The computer implemented method of claim 1, wherein a text similarity algorithm is used to detect the level of similarity between the metadata in the user's profile and the tag.

5. The computer implemented method of claim 1, wherein the tag includes a content rating wherein the content rating is a numeric value that indicates the usefulness and the appeal of the virtual universe object.

6. The computer implemented method of claim 1, wherein the tag includes a quality rating, wherein the quality rating is a rating that utilizes the Entertainment Software Rating Board (ESRB) ratings to provide further information to the user about the content and age appropriateness of the virtual universe object.

7. The computer implemented method of claim 1, wherein the virtual universe objects within the virtual universe application comprise documents, tools, and applications.

8. The computer implemented method of claim 1, wherein an application comprises a rendering of the application within the virtual universe application.

9. The computer implemented method of claim 1, wherein the user inventory is included within the user's profile, wherein the user inventory stores the virtual universe objects in a number of categories included within the user inventory.

10. The computer implemented method of claim 1, further comprising:
checking an identifier specific to the user for authentication purposes.

11. A computer program product stored on a computer readable medium for distributing virtual universe objects in a virtual universe application, the computer program product comprising:
computer useable program code for granting permission to access the virtual universe application;
computer useable program code for detecting metadata in a user's profile;
computer useable program code for detecting a virtual universe object in the region, wherein the virtual universe object includes a tag, wherein the tag comprises one or more fields;
computer usable program code for comparing the metadata and the tag to form a comparison;
computer useable program code for detecting a level of similarity between the one or more fields included with the tag and the metadata in the user's profile;
computer useable program code for responsive to detecting the level of similarity between the fields included with the tag and the metadata in the user's profile, presenting the virtual universe object to the user;
computer useable program code for receiving either an acceptance or rejection of the virtual universe object; and
computer useable program code for responsive to receiving the acceptance, including the virtual universe object in a user's inventory.

12. The computer program product of claim 11, further comprising:
detecting a trigger condition for providing the user with the virtual universe object, wherein the trigger condition comprises movement of the user within the region of the virtual universe application.

13. The computer program product of claim 11, wherein the user moves from one region to another through teleportation.

14. The computer program product of claim 11, wherein a text similarity algorithm is used to detect the level of similarity between the metadata in the user's profile and the tag.

15. The computer program product of claim 11, wherein the tag includes a content rating, wherein the content rating is a numeric value that indicates the usefulness and the appeal of the virtual universe object.

16. The computer program product of claim 11, wherein the tag includes a quality rating, wherein the quality rating is a rating that utilizes the Entertainment Software Rating Board (ESRB) ratings to provide further information to the user about the content and age appropriateness of the virtual universe object.

17. The computer program product of claim 11, wherein the virtual universe objects within the virtual universe application comprise documents, tools, and applications.

18. A data processing system for distributing virtual universe objects in a virtual universe application, the data processing system comprising:
a bus system;
a memory connected to the bus system, wherein the memory includes computer useable program code; and
a processing unit connected to the bus system, wherein the processing unit executes the computer useable program code to grant permission to access the virtual universe application; to detect a virtual universe object in the region, wherein the virtual universe object includes a tag, wherein the tag comprises one or more fields; to compare the metadata and the tag to form a comparison; to detect a level of similarity between the one or more fields included with the tag and the metadata in the user's profile; to present the virtual universe object to the user responsive to detecting the level of similarity between the fields included with the tag and the metadata in the user's profile; to receive either an acceptance or rejection of the virtual universe object; and to include the virtual universe object in a user's inventory responsive to receiving an acceptance.

19. The data processing system of claim 18, wherein a text similarity algorithm is used to detect the level of similarity between the metadata in the user's profile and the tag.

20. The data processing system of claim 18, wherein the tag includes a content rating, wherein the content rating is a numeric value that indicates the usefulness and the appeal of the virtual universe object.
